(19) United States
(12) Patent Application Publication
(10) Pub. No.: US 2010/0070845 A1
(43) Pub. Date: Mar. 18, 2010

(54) SHARED WEB 2.0 ANNOTATIONS LINKED TO CONTENT SEGMENTS OF WEB DOCUMENTS

(75) Inventors: MICHAEL D. FACEMIRE, PITTSBORO, NC (US); PROJJWAL SAHA, NEW DELHI (IN); MICHAEL C. WANDERSKI, DURHAM, NC (US); AJAMU A. WESLEY, MARLBOROUGH, MA (US)

Correspondence Address: PATENTS ON DEMAND, P.A. IBM-RSW, 4581 WESTON ROAD, SUITE 345, WESTON, FL, 33331, US

(73) Assignee: INTERNATIONAL BUSINESS MACHINES CORPORATION, ARMONK, NY (US)

(21) Appl. No.: 12/212,360

(22) Filed: Sep. 17, 2008

(51) Int. Cl. G06F 17/00; G06F 3/048

(52) U.S. Cl. 715/230; 715/753

(57) ABSTRACT

A Web document including Web content can be presented within a user interface. At least one content segment of the Web document can be associated with a visual identifier. At least one annotation can be associated with said content segment of the Web document. The annotation can be presented within an annotation view of the user interface. The annotation can include content provided by another in commentary to the Web document and in particular in commentary to the content segment of the Web document.

### BACKGROUND

The present invention relates to the field of collaboration software and Web 2.0 technologies and, more particularly, to shared Web 2.0 annotations linked to content segments of Web documents.

Web 2.0 is focused around content sharing and end-users adding value to Web content accessible by other users. Web 2.0 technologies transform a Web content paradigm from being one-way content pushing from a serving source to end-users to being a more interactive process in which users participate. Common Web 2.0 technologies include, but are not limited to, WIKIs, BLOGS, MASH-UPS, social networking sites, usenet, and the like. User reviews to purchased products, services, and/or items in which users can post comments/opinions/ratings to other users and see comments/opinions/ratings from other users is considered a Web 2.0 technique.

One problem with Web 2.0 environments is that user comments are often difficult to manage, especially when free-form content is permitted. That is, when many people provide their comments/content to parent document, it can rapidly become challenging to manage these comments in a reasonable and non-distracting fashion. For example, one content contributor can often “dominate” a Web 2.0 forum it by posting long and/or frequent content. Popular Web 2.0 forums can include on-line arguments among two or more people, which drown out other participants. Different user groups also place different emphasis on different content within a Web 2.0 forum. For example, one user can focus upon core content only and not wish to be distracted by user additions, another can want to see threaded ‘arguments” or discussions about a particular point between a small set of communicators, still another can desire to see an “overview” public opinions based upon a cross section of postings. Web 2.0 techniques for shorting/filtering/policing user provided content lack a robustness to handle varying user concerns in an intuitive fashion.

### BRIEF DESCRIPTION OF THE SEVERAL VIEWS OF THE DRAWINGS

FIG. 1 is a set of flow charts for adding annotations to Web content and acquiring/viewing annotations with Web content in accordance with an embodiment of the inventive arrangements disclosed herein.

FIG. 2 illustrates sample user interfaces enabled for annotations in accordance with an embodiment of the inventive arrangements disclosed herein.

FIG. 3 is a schematic diagram of a system for implementing annotations in accordance with an embodiment of the inventive arrangements disclosed herein.

### DETAILED DESCRIPTION

The present invention can allow users to collaborate on Web content, using annotations that are distinct from a parent document (e.g. URL addressable Web page). In one embodiment, the annotations can be able to be related to a specific item or content segment of the parent document. For example, an annotation can appear as a pop-up or fly-over window proximate to a portion of a parent document to which it relates, which can be optionally emphasized, such as through highlighting. Further, each annotation can include multiple tags, which permit annotation indexing and searching based at least in part upon the tags. Other attributes, such as an expiration date, an annotation type, and the like can be associated with each annotation. In one embodiment, other users can rate annotations, where the ratings can appear proximate to the annotation when presented. This “meta data” for each annotation can be used to sort and/or filter annotations in a recipient specific manner. For example, different people viewing the same Web content can be presented with a different annotation set for the Web content, which is tailored or customized to suit the viewer.

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, for instance, via optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

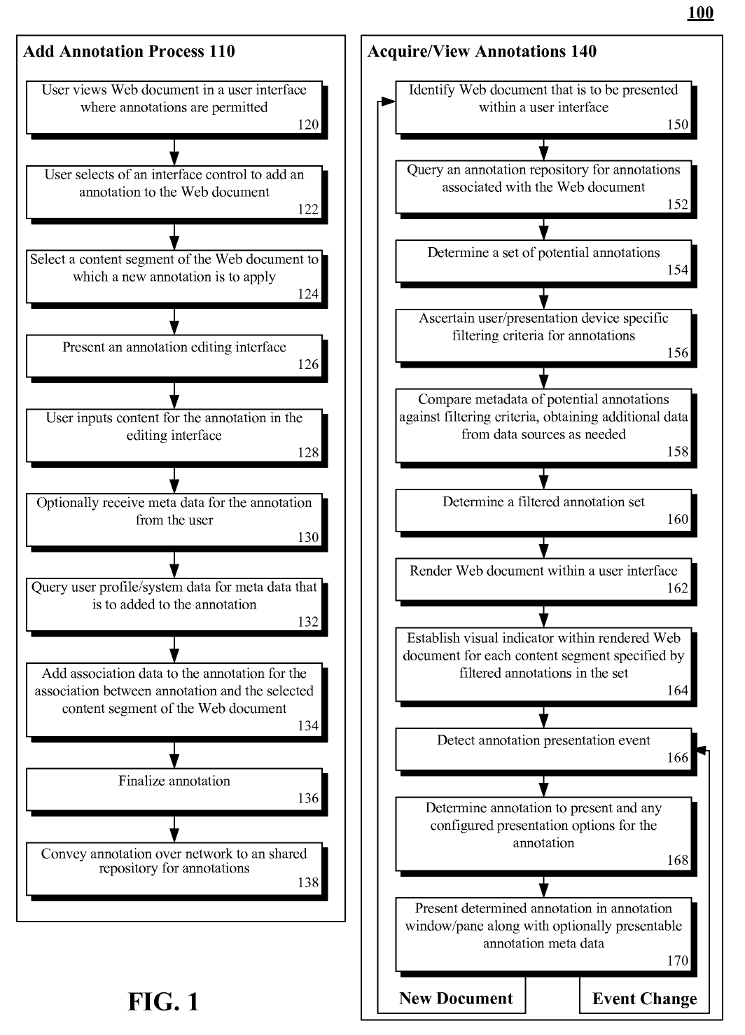

FIG. 1 is a set of flow charts for adding annotations to Web content and acquiring/viewing annotations with Web content in accordance with an embodiment of the inventive arrangements disclosed herein. Annotations can be used by users to share commentary with others and to view commentary by others, where the commentary relates to an associated Web document. An unlimited number of annotations can be associated with a single Web document. In one embodiment, the annotations can be presented within a user interface section for annotations, which is distinct from a user interface construct used to present the Web document. For example, an annotation window can be implemented as a fly-over window that automatically appears/hides based upon a pointer positioning within a window in which the Web document is presented.

More specifically, annotations can be software artifacts containing digitally encoded user-provided content, metadata, and an association with a Web document. The digitally encoded information is user commentary to a Web document, specified within the association. The commentary can relate to a specific content segment of the Web document. The metadata can be compared against filtering criteria to ensure that end-users are only provided with a filtered set of annotations relevant to them. Annotations can be an enhancement to existing Web 2.0 servers and/or can be implemented within an annotation server communicatively linked to, but distinctly implemented from Web server(s) that serve the Web documents to which the annotations relate. Two principle processes (from an end-user perspective) involving annotations are an add annotation process 110 and an acquire/view annotations process 140.

The add annotation process 110 can be a process used by users to create a new annotation that is associated with a user viewed Web content. New annotations can be conveyed to a network server, where they can be shared with others. Process 110 can begin in step 120, where a user views a Web document in a user interface. This user interface can support annotations. In one embodiment, the user interface can be a browser and the Web document can refer to any Uniform Resource Identifier (URI) addressable content object. In step 122, a user can select an interface control to add an annotation to the Web document. In step 124, a content segment of the Web document to which the new annotation is to apply can be selected. For example, a user can highlight a content segment of the Web document after being prompted to do so.

In step 126, an annotation editing interface can be presented. In step 128, a user can input content for the annotation into the editing interface. Input content can include text and other media. In step 130, the user can optionally add meta data for the annotation. For example, a user can manually enter a title, a category, an annotation type, and other such data. In step 132, additional meta data for the annotation can be automatically retrieved from a user profile/system resource and added to the annotation. For example, a current time can be one meta data element automatically added using a system resource, a computing device identifier can be another meta data element extracted from an operating system registry and added to the annotation, etc. A user profile can include a set of previously configured elements, which are added to every annotation created by the user, which can include elements such as a user name, a user occupation, alternative user identifiers (e.g., social networking user name(s), email address(es), aliases, etc.), and the like.

In step 134, association data can be added to an association of the annotation (i.e., software artifact that contains the annotation data). This annotation data can identify the Web document, such as by using the URI of the Web document. Further, the annotation data can specify a region or content segment of the Web document to which the annotation applies. In step 136, the annotation can be finalized (e.g., the software artifact that contains application data can be saved as a distinct software object). In step 138, the annotation (e.g., software artifact) can be conveyed over a network to a shared repository for annotations.

Process 140 shows how annotations can be acquired and/or viewed by users. From a user perspective, relevant annotations can automatically appear within a user interface when Web documents are acquired/presented within a user interface. Process 140 can begin in step 150, where a Web document that is to be presented within a user interface can be identified. In step 152, an annotation repository can be queried for a set of annotations associated with the Web document. In step 154, the set of potential annotations relevant to the identified Web document can be determined in response to the query.

Annotations, however, can be filtered by user specific criteria to ensure only those annotations believed to be relevant/of interest to a user are conveyed to that user. In step 156, user/presentation device (e.g., a client computer used by a user) specific filtering criteria can be ascertained for the annotations. In step 158, metadata of the potential annotations (those returned from the query) can be compared against filtering criteria. Additional data can be acquired from data sources as needed during this step 158. For example, one potential filter can limit annotations to those written by users having a “close” relationship to a current user to whom the annotations are presented. Closeness can be based upon a calculated affinity score, derived from social networking data (e.g., the data source). In step 160, a filtered annotation set can be determined.

In step 162, the Web document can be rendered within a user interface, such as a browser. In step 164, visual indicators can be established and presented within the user interface in which the Web content is presented that indicate content segments associated with annotations of the filtered set. For example, phrases and/or words that have an associated annotation set can be highlighted, presented in large font, depicted by a graphic icon, or can be visually distinguished in some other manner.

In step 166, an annotation presentation event can be detected. This event can vary significantly depending upon implementation specific choices and/or presentation characteristics established for an annotation window. For example, in one embodiment, an annotation window can be implemented as a fly-over window, which is shown when a pointer is positioned over an associated content segment of the presented Web document. The mouse-over event can be the annotation presentation event in that example. The invention is not limited in this regard, however, and an annotation interface can be an interface provided in a pane of a browser, in a pop-up window, and the like. Each implementation can have different events/triggers associated that relate to annotation presentation. In step 168, an annotation that is to be presented responsive to the event can be determined. User configured presentation options can also be retrieved at this step. In step 170, the determined annotation can be presented in accordance with the configured presentation options. For instance, one or more meta data element can be optionally presented along with annotation content. When a presentation event changes, a different annotation can be presented and/or a currently presented annotation can be hidden/changed, as shown by process 140 progressing from step 170 to step 166. When a new Web document is loaded, the process 140 can repeat for that document, as shown by progressing from step 170 to step 150.

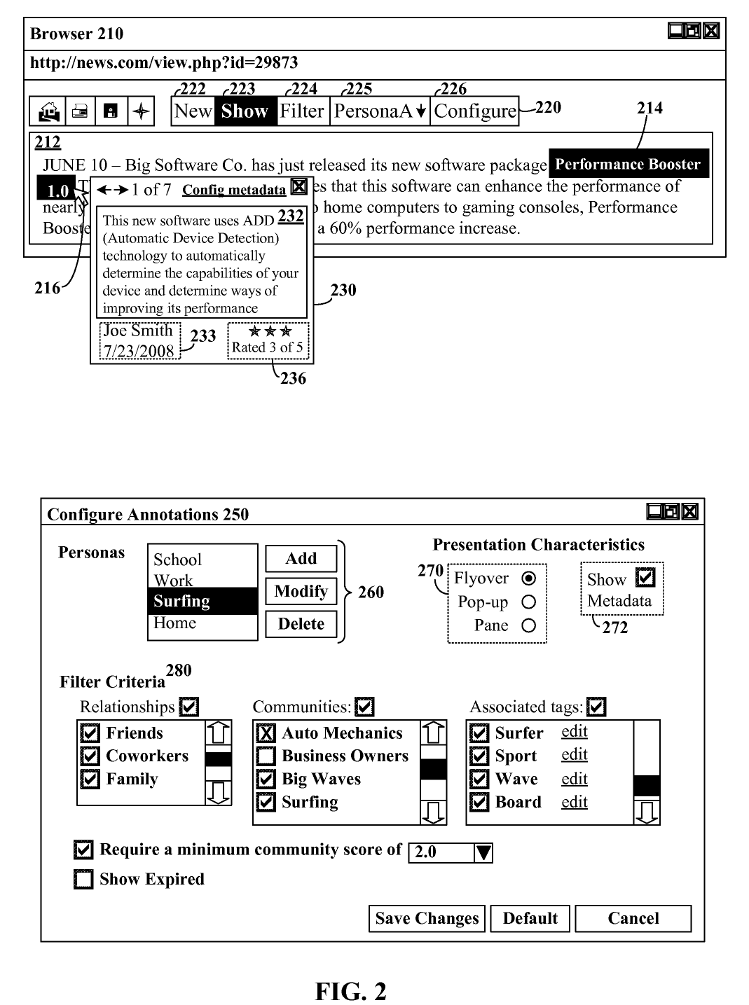

FIG. 2 illustrates sample user interfaces 210, 250 enabled for annotations in accordance with an embodiment of the inventive arrangements disclosed herein. The interfaces 210, 250 are not intended to be comprehensive or definitive. That is, deviations and alterative user interfaces are contemplated and the invention is not to be construed as limited in this regard.

Interface 210 shows a browser configured to present 212 a Web document. This interface 210 can include a toolbar 220 for annotations. The toolbar can include a number of user selectable controls, such as one for establishing a new annotation 222, one to show/hide 223 annotations, one or selectively apply annotation filters 224, one indicating an active annotation persona 225, one to configure annotation related options 226, and the like. Use of a toolbar 220 is just one contemplated way of providing a user with annotation related options, and menus, hot-key combinations, and other interface control types can be used in other implementations to approximately equivalent effect.

An annotation window 230 can exist that is distinct from the section 212 of interface 210 in which the Web document is presented. Annotation window 230 can be implemented as a selective presentable pane of browser 210, as a pop-up window, as a fly over window (as illustrated), and the like. Annotation window 230 can present annotation content 232 and one or more optional meta data elements 233, 236. Annotation window 230 can also have a set of controls, such as a navigation control to navigation among a set of annotations for the Web document 212 rendered in the interface 210. Presentation options, such as configuring annotation metadata presentation/hiding can also be included within window 230. For example, an annotation author and creation date 233 can be optionally shown in window 230, as can an annotation rating 236, and other meta data related content.

Content 212 of a Web document can be annotated to visually depict content segments 214 that are associated with an annotation. Visual indicators for content segments 214 can include highlighting the segment, using a distinctive font type/typeface option/size/foreground color/background color, using a graphic to indicate a presence of an annotation, and the like. As illustrated, the content segment 214 is highlighted as enabled for mouse-over event detection. That is, when a pointer 216 is positioned proximate to the region 214 for an established time, window 230 is automatically presented, with annotation content 232 associated with region 214 being loaded. When the pointer 216 is moved, fly-over window can be hidden. Multiple different annotations can be associated with a single content segment 214, such as when a threaded discussion related to an initially commentary exists. In one embodiment, window 230 can concurrently show multiple annotations 232 when each relates to a single segment 214. In one embodiment, multiple different windows 230 can concurrently be displayed, where each presents content 232 related to a selected content segment 214 (assuming multiple annotations are associated with a single segment 214.

Although interface 210 is shown as a browser interface, the disclosure is not to be limited in this regard. In various contemplated embodiments, Web content/Web documents and their corresponding annotations can be presented within any type of interface, such as a rich internet interface (RII), an internet-enabled desktop gadget, and the like. Further interfaces 210, 230, 250 are not limited to graphical user interfaces (GUIs), but can be implemented as text user interfaces (TUIs), voice user interfaces (VUIs), multimodal interfaces, and the like in various contemplated embodiments.

Configuration interface 250 is a sample interface for configuring annotation behavior. Various user configurable settings are shown, such as permitting a user to specify filter criteria 280 and to define presentation characteristics 270, 272 of the interface 210 and/or window 230. The presentation characteristics can include an option 270 changing an annotation window from different types of “window” containers. For example, the annotation window 230 can be selectively changed from a fly-over window, to a pop-up, to a pane, as shown. In addition, an option 272 can permit metadata relating to an annotation to be either shown or suppressed. This control can be performed at lower levels, as shown by the “configure metadata option” illustrated in window 230.

Any number of user settings can be used to establish different filter criteria 280. For example, relationship filtration criteria can be established that selects annotations based upon a relationship of the author to a user. Another filter criteria 280 can be to permit different groups of authors to either be included or excluded. Groups can be based upon any definable factor. As shown, auto mechanics (e.g., annotations from any author who is an auto mechanic) can be explicitly excluded when filtering, and hobbyist groups for “big waves” and “surfing” in general can be explicitly allowed. Business owners, shown as unmarked in the community filter criterion are ignored when filtering (i.e., other filter criteria can be used to determine if annotations authored by business owners are to be included in a filtered set or excluded). Filtering can be performed based upon tags of the annotations and sets of keywords (sets as shown include surfer, sport, wave, and board). These keyword sets can function as white and black lists when compared against tags of annotations. Other criteria can be based upon a community score value, whether a tag has expired as per an internal expiration element or calculated from creation date, and the like. In one embodiment, an evaluation order for the filter criteria 280 can be established to resolve potential conflicts among different filter criteria. In another embodiment, the various criteria can result in criteria specific scores, which form an annotation score, which determines whether an annotation is filtered or not (i.e., the annotation score can be compared against an upper and/or lower threshold value for including/excluding annotations).

Personas 260 represent a recognition that browser usages can differ situationally, as can user desired annotations. Different personas 260 can represent different environments and/or purposes for which browsing of Web documents occurs. For example, annotations specific to work-related purposes (and associated relevant annotations) can different substantially from annotations applicable to academic situations, personal curiosity situations, and the like. Thus, a single user can specify different annotation filtering criteria depending upon a browsing situation. Thus, a user can have a work persona, a school persona, and/or a recreational persona, each having different annotation settings. Further, evaluation processing of different criteria 280 can vary based upon different personas. For example, a relationship criteria for a work persona can be evaluated differently than a relationship criteria for a recreational persona. Personas can also affect an annotation profile, which is a profile that automatically determines metadata that is to be included for newly created (using control 222) annotations.

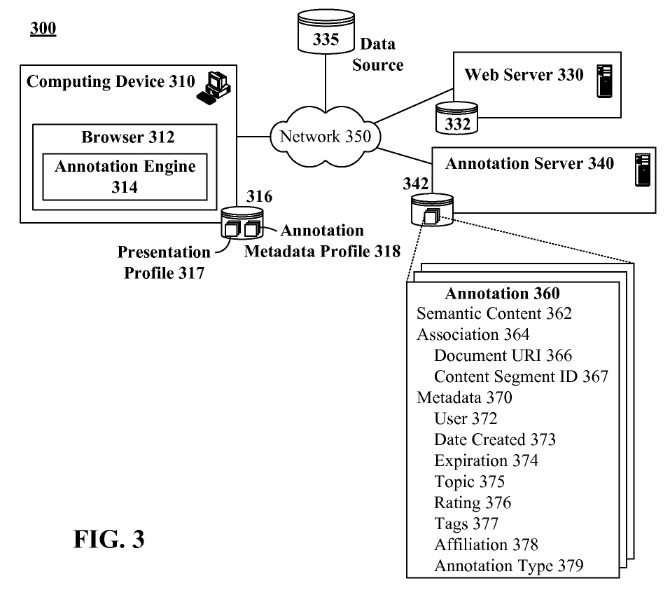

FIG. 3 is a schematic diagram of a system 300 for implementing annotations in accordance with an embodiment of the inventive arrangements disclosed herein. System 300 can be used to implement method 100. In system 300, a computing device 310, Web server 330, annotation server 340, and one or more data sources 335 can be communicatively linked to a network 350. The Web server 330 can include a data store 332 of Web documents, which can be served to computing device 310. For example, a browser 312 of device 310 can request a Web document by URI, which is conveyed by server 330, processed by device 310 hardware, and presented upon an output device, such as a display.

The browser 312 can include an annotation engine 314 that conveys the URI of the Web document to an annotation server 340. The annotation server 340 can query a data store 342 of annotations 360 and convey a set of annotations 360 having the URI 366 to device 310. These annotations 360 can be presented in a user interface when the associated Web document, as shown and described in interface 210. In one embodiment, the annotations 360 presented in the user interface can be filtered based upon device 310 specific or user (of device 310) specific criteria. For example, various filtration criteria can be compared against metadata 370 values of the annotations. Information from one or more data source 335 can be needed to evaluate the filtration criteria.

Each annotation 340 can include semantic content 362, an association 364, and meta data 370. The semantic content 362 can be user provided and shared content that is a commentary on a Web document. The association 364 can include a Web document identifier 366 and a content segment identifier 367. The Web document identifier can be any identifier, such as a URI. The content segment identifier 367 can indicate a portion of the Web document to which the semantic content 362 applies. In one embodiment, the content segment 367 can be associated with a text string (e.g., text such as a word, phrase, paragraph, etc.), a media object (e.g., graphic, table, video, sound file), and any other identifiable object of a Web document. When the content segment 367 is blank (or set to a reserved value) the annotation 360 can be considered a general annotation applying to the entire Web document. In one embodiment, the association 364 can be enhanced to point to a different annotation and/or annotation segment, which is useful when annotations are permitted against other annotations.

The metadata 370 can include any of a variety of elements including, but not limited to, elements 372-379. One element can be a user 372 element indicating an author of the annotation 360. A date created element 373 can indicate when the annotation 360 was authored. Expiration element 374 can indicate a time/date that an annotation 360 is to self-terminate. Topic element 375 can include a subject or title of the annotation 360. Rating element 376 can be a community established rating of the relevancy and/or value of the annotation 360. The tags element 377 can include a set of one or more tags, such as community established tags or tags representing key words corresponding to the semantic content 362. The affiliation element 378 can include a set of one or more groups associated with the user 372. The annotation type element 379 can include a value for a predefined category suitable for the annotation 360.

Data store 316 of computing device 310 can include device 310 and/or user specific data, such as presentation profile 317 and annotation metadata profile 318. The presentation profile 317 can include user configured presentation settings for annotations. The annotation metadata profile 318 can be a profile of metadata elements that are to be applied automatically when a user of device 310 creates a new annotation 360.

It should be appreciated that the component arrangements of system 300 are specific to one embodiment and the disclosure is not to be limited in this manner. For example, in one contemplated embodiment, the profiles 317, 318 can be stored within data store 342 and many functions attributed to engine 314 can be implemented by annotation server 340. In another embodiment, the annotation engine 340 and annotations 360 can be integrated with Web server 330 and stored Web documents.

As used in system 300, a Web document can refer to any electronic document able to be uniquely identified. A Web document can be a HTML based document, an application document, a text document, a media object, and any other type of digitally file.

Browser 312 is any application able to render a Web document as defined above and to show associated annotations. A browser 312 can include a Web browser, a stand-alone application, a rich internet interface (RII), a desktop gadget, and the like.

Computing device 310 can be any machine that permits a user to interact with Web documents and annotations. For example, computing device 310 can include, but is not limited to, a personal computer, a kiosk, a mobile phone, a Web tablet, and the like.

Server 330 and/or server 340 can each be implemented as a set of one or more devices that serve documents/annotations over network 350 to requesting devices 310. Server 330, 340 can include hardware, software, and firmware components capable of performing the functions described herein. Each of the servers 330, 340 can be implemented as stand-alone computing devices, as a distributed set of computing devices, as a virtual server, as a cluster of devices, and the like.

Data store 316, 332, 342, and 340 can be physically implemented within any type of hardware including, but not limited to, a magnetic disk, an optical disk, a semiconductor memory, a digitally encoded plastic memory, a holographic memory, or any other recording/storage medium. The data store 316, 332, 342, and 340 can be a stand-alone storage unit as well as a storage unit formed from a plurality of physical devices, which may be remotely located from one another. Additionally, information can be stored within each data store 316, 332, 342, and 340 in a variety of manners. For example, information can be stored within a database structure or can be stored within one or more files of a file storage system, where each file may or may not be indexed for information searching purposes.

Network 350 can include any hardware/software/and firmware necessary to convey digital content encoded within carrier waves. Content can be contained within analog or digital signals and conveyed through data or voice channels and can be conveyed over a personal area network (PAN) or a wide area network (WAN). The network 350 can include local components and data pathways necessary for communications to be exchanged among computing device components and between integrated device components and peripheral devices. The network 350 can also include network equipment, such as routers, data lines, hubs, and intermediary servers which together form a packet-based network, such as the Internet or an intranet. The network 350 can further include circuit-based communication components and mobile communication components, such as telephony switches, modems, cellular communication towers, and the like. The network 350 can include line based and/or wireless communication pathways.

The flowchart and block diagrams in the FIGS. 1-3 illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A method for collaborating on served Web documents comprising:
presenting a Web document comprising Web content within a user interface, wherein at least one content segment of the Web document is associated with a visual identifier;
identifying at least one annotation associated with said content segment of the Web document;
presenting within an annotation view of said user interface the at least one annotation, wherein said annotation comprises content provided by another in commentary to the Web document and in particular in commentary to the content segment of the Web document.

2. The method of claim 1, further comprising:
detecting a mouse-over event, where a pointer shown in the user interface is positioned proximate to the visual identifier; and
responsive to the mouse-over event, presenting the annotation view, which is contained in a fly-over window distinct from an interface window in which the Web document is presented.

3. The method of claim 1, further comprising:
detecting a user selection to add an annotation to the Web document;
receiving a selection of a portion of the Web document;
presenting a content input control;
receiving user provided input entered into the content input control;
determining a content segment of the Web document associated with the received selection of the portion of the Web document;
saving a new annotation comprising the user provided input, wherein the new annotation is associated with the determined content segment of the Web document; and
conveying the new annotation to a network element, which shares annotations with remotely located users requesting the Web document.

4. The method of claim 1, further comprising:
detecting a plurality of annotations associated with the Web document;
determining previously defined filtering criteria for annotations;
comparing the previously defined filtering criteria against metadata of the annotations;
based upon results of the comparing, ascertaining a subset of the plurality of annotations that are available for presentation within the annotation view; and
selectively presenting each of the subset of annotations within the annotation view responsive to an occurrence of a triggering condition.

5 . The method of claim 4, wherein the filtering criteria bases the filtering at least in part upon a relationship between a user of the user interface and an owner of the annotations.

6. The method of claim 4, wherein the filtering criteria bases the filtering at least in part upon semantic content of the annotation as compared against a defined set of keywords, wherein the keywords comprise at least one of a white list and a black list defining content of interest to a user of the user interface.

7. The method of claim 4, wherein the filtering criteria bases the filtering at least in part upon community determined rating of each of the annotations.

8. A computer program product for collaborating on served Web documents comprising:
a computer usable medium having computer usable program code embodied therewith, the computer usable program code comprising:
computer usable program code configured to present a Web document comprising Web content within a user interface, wherein at least one content segment of the Web document is associated with a visual identifier;
computer usable program code configured to identity at least one annotation associated with said content segment of the Web document;
computer usable program code configured to present within an annotation view of said user interface the at least one annotation, wherein said annotation comprises content provided by another in commentary to the Web document and in particular in commentary to the content segment of the Web document.

9. A system for collaborating on served Web documents comprising:
at least one software artifact stored in a storage medium comprising:
digitally encoded semantic content;
metadata comprising a user identifier of a user who created the semantic content, a date the semantic content was created;
an association with a Web document, wherein said Web document is associated with a unique Uniform Resource Identifier (URI), which is able to be utilized to access said Web document over a network from a remotely located computing device linked to the network, wherein said association specifies a content segment of the Web document to which the software artifact applies, wherein said metadata of said software artifact is an autonomous software object distinct from said Web document, wherein said metadata is distinct and different from metadata associated with the Web document, and wherein said software artifact is configured to permit a plurality of software artifacts to be associated with the Web document.

10. The system of claim 9, further comprising:
a browser configured to render said Web document within a user interface; and
an annotation window configured to present said digitally encoded semantic content when said Web document to which the association applies is rendered within the browser;

11. The system of claim 10, wherein said browser is configured to present a visual indicator of the content segment specified by the association when visually presenting the rendered Web document.

12. The system of claim 11, wherein said visual indicator is configured to distinguish itself in at least one of the following manners: using highlighting to distinguish the content segment, using a distinctive font to distinguish the content segment, using a distinctive font color to distinguish the content segment, using a distinctive background color to distinguish the content segment, presenting a graphical object proximate to the content segment to distinguish the content segment.

13. The system of claim 11, wherein said annotation window is a fly-over window selectively presented within the user interface when a pointer of a user interface is positioned proximate to the visual indicator of the content segment.

14. The system of claim 11, wherein said at least one software artifact comprises a plurality of software artifacts associated with said Web document, wherein said browser is configured to present a visual indicator for each of the plurality of software artifacts to indicate the content segment of the association of each of the software artifacts.

15. The system of claim 10, wherein said annotation window is configured to permit users of the user interface to create new software artifacts for Web documents presented within the browser.

16. The system of claim 9, further comprising:
a set of software artifacts;
at least one filter object digitally encoded within a storage medium, said filter object comprising user established software artifact filtering criteria; and
an artifact filter configured to compare the user established software artifact filtering criteria against the metadata and to produce a subset of artifacts satisfying the filtering criteria.

17. The system of claim 9, wherein each of said at least one software artifact is an annotation, said system further comprising:
an annotation server communicatively linked to said network configured to serve annotations over said network to the remotely located computing devices linked to the network when Web documents associated with serviced annotations are served to the remotely located computing devices.

18. The system of claim 17, wherein said annotation server is implemented in a server distinct and different form a Web server that serves said Web documents.

19. The system of claim 9, wherein said metadata comprises an expiration date applicable to the software artifact.

20. The system of claim 19, wherein said metadata comprises a rating for the software artifact based upon feedback of a plurality of users to which the software artifact was previously presented.
